(19) United States
(12) Patent Application Publication
(10) Pub. No.: US 2026/0316953 A1
(43) Pub. Date: Oct. 15, 2026

(54) METHOD FOR MANAGING THE SETTING OF A BAROMETRIC ALTIMETER PRESENT IN AN AIRCRAFT

(71) Applicant: AIRBUS OPERATIONS SAS, Toulouse (FR)

(72) Inventors: Thierry BOURRET, Toulouse (FR); Catherine BODINEAU, Toulouse (FR)

(73) Assignee: AIRBUS OPERATIONS SAS, Toulouse (FR)

(21) Appl. No.: 19/646,215

(22) Filed: Apr. 13, 2026

(30) Foreign Application Priority Data
Apr. 15, 2025 (FR) 2503999

(51) Int. Cl. B64D 43/00; B64F 5/60; G01C 5/06; G08G 5/24

(52) U.S. Cl. CPC B64D 43/00; B64F 5/60; G01C 5/06; G08G 5/24

(57) ABSTRACT

A method for managing the setting of a barometric altimeter present in a given aircraft is disclosed. K aircrafts of interest are selected, each including an altimeter set with a specific barometric reference value. A first barometric reference value specific to the given aircraft is determined as a function of the K values specific to the K aircraft of interest. At least one action is performed (among: triggering an alert if a deviation between first and reference values entered by the given aircraft's crew is greater than a threshold; suggesting to the given aircraft's crew to use the first value to set the altimeter present in the given aircraft; and using the first value to automatically set the given aircraft's altimeter). It provides a high-precision solution (very low probability of error) not requiring modifying the ATC procedure or the standard tools used by the crew.

### TECHNICAL FIELD

The field of the invention is that of barometric altimeters present in aircraft.

The present invention relates more specifically to a method and system for managing the setting, with a barometric reference value, of a barometric altimeter present in an aircraft.

### PRIOR ART

In modern commercial aviation, the altitude of an aircraft is most often a barometric altitude (also called pressure altitude), determined by a barometric altimeter that measures the static pressure surrounding the aircraft.

Altitude is the main parameter used by air traffic controllers (persons responsible for providing an air traffic control (ATC) service) to separate aircraft. It is therefore essential that all aircraft have the same altitude reference to ensure safe vertical separation. To achieve this objective, the standard practice is for the ATC air traffic controller to transmit, to the aircraft crew, a barometric reference (barometric setting reference or barometric pressure setting) to be used to set the barometric altimeter, also known as altimeter setting or zero setting.

Three barometric references may be used: the “Standard” reference (which represents the pressure of 1013 hPa), the “QNH” reference (which represents atmospheric pressure measured at mean sea level), and the “QFE” reference (which represents ground pressure of the field on which the aircraft is operating, for example the runway from which the aircraft is taking off). For take-off and landing, most air traffic controllers use the QNH reference. When this QNH reference is used, the barometric altimeter is set so as to display the altitude of the airport once on the ground.

There are two main ways to transmit the barometric reference to the aircraft crew:
using the ATIS (Automatic Terminal Information Service), which is an automatic voice message broadcasting service (every major airport has an ATIS frequency), allowing pilots (crews) to receive essential information continuously, in particular before take-off and approach operations; and
using the air traffic control (ATC) service, with an air traffic controller who uses voice to communicate with the pilot (crew) and carry out a control operation comprising in particular confirmation of the barometric reference (QNH or QFE).

Pilots generally listen to the ATIS before contacting the air traffic control (ATC) service. If the barometric reference value changes between the time when the crew listens to the ATIS (generally before starting the descent) and the time when the aircraft enters an ATC sector, the barometric reference that is supposed to be used is the one transmitted to the crew by ATC (by voice). Standard phraseology and the crew's knowledge allow ATC to verify that the crew is using the correct barometric reference value.

Prior to take-off, the crew generally listens to the ATIS and enters the barometric reference value supplied by the ATIS while preparing the cockpit. In flight, the crew generally enters the barometric reference value received from the ATIS before starting the descent in order to regulate the cabin pressure (QNH at destination), and then each crew member sets their own barometric reference value when received from ATC. An alert is generated if the values entered by the two crew members differ. It should be noted that the value entered during the cruise phase may be slightly different from that supplied by ATC when entering the ATC sector (due to the change over time).

Some airports are equipped with a “digital ATIS” that transmits information relating to the barometric reference in digital form.

Most aircraft are also equipped with a capability of broadcasting, in S mode, the barometric reference (or barometric pressure setting, BPS) resulting from the crew's selection. However, only a few air traffic control (ATC) services have developed an alert system that makes it possible to detect an aircraft not using a correct barometric reference. With this alert system, when a significant error is detected, ATC asks the crew to verify the QNH reference or communicate the value being used.

In the abovementioned standard practice (that is to say when the ATC air traffic controller orally transmits the barometric reference to the aircraft crew), the risk of human error, although minimized, is not zero. Indeed, the following errors may occur without the crew receiving a positive alert:
ATC transmits an incorrect barometric reference value. For example, “one zero one zero” (1010) instead of “one zero zero one” (1001);
the crew misunderstands the barometric reference value supplied by ATC, in particular for persons whose native language is not English; and
the crew makes a mistake when entering the barometric reference value supplied by ATC. For example, a digit inversion, such as 1021 instead of 1012.

All these errors may go unnoticed because no positive alert is given to the crew, in particular during the approach phase. These errors may significantly reduce vertical separation, degrade operations (increase the risk of go-around) due to an inaccurate vertical guidance reference, or else degrade precision in terms of determining the minimum visibility threshold necessary for safe operation.

There are some solutions for minimizing the impact of these errors, for example:
the TCAS (traffic alert and collision avoidance system) ensures safe separation of aircraft without using barometric reference values;
the GPWS (ground proximity warning system) alerts the crew if the aircraft gets too close to the ground using a geometric altitude (based on a radio altimeter (RA) or GPS) that does not use barometric reference values; and
the crew may be alerted if a significant error is detected between the barometric reference value that is entered and an “estimated barometric reference” based on knowledge of the aircraft's geographical altitude (generally using GPS information), the altitude of the destination runway and measured atmospheric parameters (pressure, temperature, etc.). However, this method assumes a “standard” atmosphere (exhibiting a standard decrease in temperature with altitude), which might not be the case. Therefore, this method is able to detect only significant barometric reference errors (typically around 10 hPa).

Among all the known solutions discussed above, none of them is able, on its own, to be precise enough to detect all barometric reference errors, or have the appropriate level of integrity to guarantee that no unwarranted alerts are output to the crew. In particular:
(1) the known solution based on an “estimated barometric reference” is able to trigger an alert only when significant errors are made, generally around 10 hPa, and therefore cannot provide the exact expected value. Such a solution may be adjusted so as not to give unwarranted alerts, but it is not capable of detecting all possible errors, or of suggesting the correct value to be entered by the crew;
(2) the known solution in which the barometric reference is received from the ATIS of the destination airport, in the cruise phase before descent, and entered by the crew to regulate cabin pressure, could be used to trigger an alert if the barometric reference value that is entered subsequently differs from that entered in the cruise phase. However, this value may change between preparing and executing the approach. Such a solution could cause unwarranted alerts;
(3) the known solution based on the digital ATIS could be used by systems on board aircraft to detect a potential inconsistency between the barometric reference value entered in the aircraft after a voice exchange with ATC and the one received from the digital ATIS. However, integrity would not be ensured (on the ground or at transmission or at reception), since ATC assumes that the value used by the crew is the one transmitted by voice by the active air traffic controller. This could also pose security problems (risk of hacking). Guaranteeing that the value transmitted by the digital ATIS is the same as that supplied by the active ATC air traffic controller would require additional monitoring devices and/or additional tasks for the air traffic controller, which cannot be presumed to be carried out by all ATC. Such a solution could give rise to unwarranted alerts and pose safety problems; and
(4) a voice recognition technique could be used to decode the voice authorization from ATC and retrieve therefrom the barometric reference supplied by ATC, given that the aeronautical phraseology of this voice authorization is relatively standard. This would make it possible to compare the barometric reference value entered by the crew with the one decoded by such a system. However, such a solution would not be able to detect an error made by the air traffic controller (ATC). In addition, such a solution would have to cope with the variety of English accents throughout the world. Such a solution could cause a large number of unwarranted alerts.

In summary, the known solutions described above are satisfactory, but none of them is able, on its own, to detect any potential barometric reference error and supply a relevant alert to the crew without modifying the ATC procedure and/or the standard tools used by the crew. Likewise, none of the known solutions described above is able to be used on its own, without modifying the ATC procedure and/or the standard tools used by the crew, to suggest to the crew which barometric reference value to use, or to cooperate with a device that makes it possible to set, automatically (without the involvement of the crew) and precisely (with the correct barometric reference), the barometric altimeter present in the aircraft. There is therefore a need to further improve the known solutions described above.

### SUMMARY OF THE INVENTION

What is proposed is a method for managing the setting of a barometric altimeter present in a given aircraft, the method being implemented by a setting management system comprising electronic circuitry, the method comprising:
selecting a set comprising K aircraft of interest, distinct from the given aircraft, with K ≥2, as a function of at least one selection criterion, each of the aircraft of interest comprising a barometric altimeter set with a barometric reference value specific to said aircraft of interest;
determining a first barometric reference value specific to the given aircraft, as a function of the K barometric reference values specific to the K aircraft of interest; and
performing at least one action belonging to a group comprising:
   triggering an alert if a deviation between the first barometric reference value and a barometric reference value entered by a crew on board the given aircraft is greater than a predetermined threshold;
   suggesting to the crew on board the given aircraft to use the first barometric reference value to set the barometric altimeter present in the given aircraft; and
   supplying the first reference value to an automatic barometric altimeter setting device for setting the barometric altimeter present in the given aircraft.

The method furthermore comprises:
obtaining at least one other barometric reference value specific to the given aircraft, each other barometric reference value being supplied by a distinct source and not being determined as a function of the K barometric reference values specific to the K aircraft of interest; and
determining, within a set of values comprising the first barometric reference value and said at least one other barometric reference value, a particular barometric reference value having a number of occurrences greater than or equal to a predetermined value greater than or equal to two; and, when said at least one action is performed, the particular barometric reference value is used instead of the first barometric reference value if the particular barometric reference value is different from the first barometric reference value.

The proposed solution thus makes it possible to determine a barometric reference value specific to a given aircraft, using barometric reference values specific to other aircraft (referred to here as aircraft of interest). Among various actions for managing the setting of the barometric altimeter of the given aircraft, each using the barometric reference value thus determined, one or more are performed (triggering an alert and/or suggesting to the crew the barometric reference value to be used and/or automatically setting the barometric altimeter). The proposed solution has numerous advantages. It is highly precise, that is to say with a very low probability of error with regard to the barometric reference determined for the given aircraft, since it is based on the fact that the probability of crews of different aircraft of interest having entered an incorrect barometric reference value is extremely low. In addition, it does not require modifying the ATC procedure or the standard tools used by the crew.

According to one particular embodiment, determining the first barometric reference value comprises:
determining, among the K aircraft of interest, at least N aircraft of interest sharing one and the same particular barometric reference value, with 2≤N≤K; and
adopting, for the first barometric reference value, the particular barometric reference value shared by the at least N aircraft of interest. According to one particular embodiment, said at least one selection criterion belongs to a group comprising:
a first sub-group comprising: to be an aircraft of interest, a candidate aircraft must be in flight; to be an aircraft of interest, a candidate aircraft must be on the ground, at a destination airport of the given aircraft, and on a runway or at a distance from a runway less than a first predetermined distance threshold; to be an aircraft of interest, a candidate aircraft must be on the ground and with a ground speed greater than a predetermined speed threshold;
a second sub-group comprising: to be an aircraft of interest, a candidate aircraft must be at a distance, from the destination airport of the given aircraft, less than a second predetermined distance threshold; to be an aircraft of interest, a candidate aircraft must be at a distance, from a runway of the destination airport of the given aircraft, less than a third predetermined distance threshold; to be an aircraft of interest, a candidate aircraft must belong to a set of M aircraft in flight closest to the destination airport of the given aircraft, with 2≤M≤K; to be an aircraft of interest, a candidate aircraft must be located in an ATC control sector around the destination airport of the given aircraft;
a third sub-group comprising: to be an aircraft of interest, a candidate aircraft must be at a height, above the destination airport of the given aircraft, less than a first predetermined height threshold; to be an aircraft of interest, a candidate aircraft must be at a height, above the destination airport of the given aircraft, less than a second predetermined height threshold if the candidate aircraft is in the climbing phase and less than a third predetermined height threshold, different from the second height threshold, if the candidate aircraft is in the descent phase; to be an aircraft of interest, a candidate aircraft must be at an altitude lower than a current altitude of the given aircraft, if the given aircraft is approaching the destination airport of the given aircraft.

According to one particular embodiment, the set of K aircraft of interest is selected as a function of at least one combination of criteria comprising at least one selection criterion from the first sub-group, at least one selection criterion from the second sub-group and at least one selection criterion from the third sub-group.

According to one particular embodiment, at least one distance, among the distance from the destination airport and the distance from a runway of the destination airport, is weighted as a function of a deviation between a position of the candidate aircraft and the centreline of a runway intended for the given aircraft at the destination airport.

According to one particular embodiment, the first predetermined height threshold depends on at least one item of information among a transition altitude and a transition level that are predefined for the destination airport of the given aircraft.

According to one particular embodiment, within the set of values, the occurrence of a barometric reference value supplied by a given source is weighted by a coefficient dependent on a priority level associated with said given source, and the number of occurrences of the particular barometric reference value takes into account the weighting of each occurrence.

According to one particular embodiment, a choice of the one or more actions performed depends on the number of occurrences of the particular barometric reference value.

According to one particular embodiment, said at least one other barometric reference value is supplied by a source belonging to a group comprising:
a first source supplying a barometric reference value entered by the crew on board the given aircraft, during a cruise phase of the given aircraft before starting a descent;
a second source supplying a barometric reference value received via a “digital ATIS” service broadcast by the destination airport of the given aircraft;
a third source supplying a barometric reference value resulting from application of a voice recognition technique to a voice authorization transmitted by an air traffic control (ATC) service for the destination airport of the given aircraft; and
a fourth source supplying an estimate of a barometric reference value based on measurements supplied by sensors on board the given aircraft, location information supplied by a satellite positioning system (GPS) and known altitude information concerning the destination airport of the given aircraft.

What is also proposed is a computer program product comprising instructions that cause a processor to carry out the method discussed above according to any one of its embodiments when said instructions are executed by the processor.

What is also proposed is a storage medium storing such instructions that cause the processor to carry out the method discussed above according to any one of its embodiments when said instructions are read from the storage medium and executed by the processor.

What is also proposed is a system for managing the setting of a barometric altimeter present in a given aircraft, comprising electronic circuitry configured to implement the following:
selecting a set comprising K aircraft of interest, distinct from the given aircraft, with K≥2, as a function of at least one selection criterion, each of the aircraft of interest comprising a barometric altimeter set with a barometric reference value specific to said aircraft of interest;
determining a first barometric reference value specific to the given aircraft, as a function of the K barometric reference values specific to the K aircraft of interest; and
performing at least one action belonging to a group comprising:
triggering an alert if a deviation between the first barometric reference value and a barometric reference value entered by a crew on board the given aircraft is greater than a predetermined threshold;
suggesting to the crew on board the given aircraft to use the first barometric reference value to set the barometric altimeter present in the given aircraft; and
supplying the first reference value to an automatic barometric altimeter setting device for setting the barometric altimeter present in the given aircraft.

The electronic circuitry is furthermore configured to:
obtain (403) at least one other barometric reference value specific to the given aircraft, each other barometric reference value being supplied by a distinct source and not being determined as a function of the K barometric reference values specific to the K aircraft of interest; and
determine (404), within a set of values comprising the first barometric reference value and said at least one other barometric reference value, a particular barometric reference value having a number of occurrences greater than or equal to a predetermined value greater than or equal to two;

and, when said at least one action is performed (405), use the particular barometric reference value instead of the first barometric reference value if the particular barometric reference value is different from the first barometric reference value.

More generally, what is proposed is a system for managing the setting of a barometric altimeter, configured to perform the method discussed above according to any one of its embodiments.

What is also proposed is an aircraft comprising a system for managing the setting of a barometric altimeter as discussed above.

### BRIEF DESCRIPTION OF THE DRAWINGS

The abovementioned features of the invention, as well as others, will become more clearly apparent on reading the following description of at least one exemplary embodiment, said description being given with reference to the appended drawings, in which:

FIG. 1 schematically illustrates a side view of an aircraft equipped with a system for managing the setting of a barometric altimeter;

FIG. 2 schematically illustrates an exemplary hardware architecture of the system for managing the setting of a barometric altimeter of FIG. 1;

FIG. 3 schematically illustrates an algorithm for managing the setting of a barometric altimeter, executed by the system shown in FIG. 1, in a first embodiment;

FIG. 4 schematically illustrates an algorithm for managing the setting of a barometric altimeter, executed by the system shown in FIG. 1, in a second embodiment; and

FIG. 5 schematically illustrates a distance weighting as a function of a deviation between a position of a candidate aircraft and the centreline of a runway intended for the given aircraft at the destination airport.

### DETAILED DESCRIPTION OF EMBODIMENTS

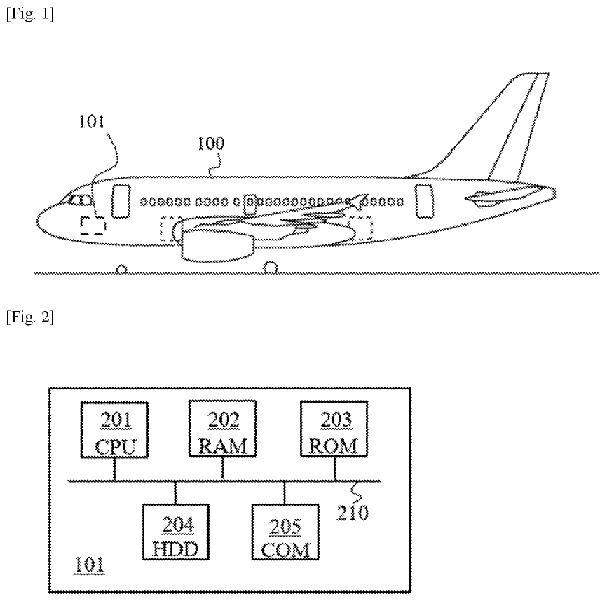

FIG. 1 schematically illustrates a side view of an aircraft 100 equipped with a system 101 for managing the setting of a barometric altimeter present in an aircraft. This system 101 comprises electronic circuitry. It will also sometimes be called an “altimeter setting management system” below. In the embodiment of FIG. 1, the altimeter setting management system 101 is an item of electronic equipment on board the aircraft 100. For example, it forms part of electronic circuitry of the avionics of the aircraft 100. It is for example integrated into a computer of the aircraft 100, or else distributed across multiple computers of the aircraft 100.

As detailed below, the altimeter setting management system 101 is configured to determine a first barometric reference value specific to the aircraft 100 and to perform at least one action using this first value (among: triggering an alert as a function of the first value; suggesting to the crew to use the first value; and supplying the first value to an automatic barometric altimeter setting device).

In one variant, the altimeter setting management system 101 is not on board the aircraft 100, but is present on the ground. It then comprises means for communicating with the aircraft 100 for the purpose of transmitting elements relating to the performance (on the ground) of the one or more actions using the first value. For example: transmitting, to the aircraft 100, information relating to the alert triggered as a function of the first value; or transmitting, to the aircraft 100, the first value in the event that use thereof is suggested to the crew; or else transmitting, to the aircraft, the first value with a view to it being used by the automatic barometric altimeter setting device.

In another variant, the altimeter setting management system 101 comprises a first part on board the aircraft 100 and a second part present on the ground. The operations (method steps) carried out by the system 101 may thus be distributed between the two parts of the system 101. For example, the first part (on the ground) determines the first value and transmits it to the second part (on board the aircraft), which performs one or more of the abovementioned actions, using the first value.

FIG. 2 schematically illustrates an exemplary hardware architecture of the altimeter setting management system 101 of FIG. 1, which then comprises the following, connected by a communication bus 210: a processor (or central processing unit, CPU) 201; a random access memory (RAM) 202; a read-only memory (ROM) 203 (for example a flash memory); a data storage device, such as a hard disk drive (HDD), or a storage medium reader, such as a Secure Digital (SD) card reader 204; at least one communication interface 205 allowing the system 101 to interact with the avionics of the aircraft 100.

The processor 201 is capable of executing instructions that form a computer program and that are loaded into the RAM 202 from the ROM 203, from an external memory (not shown), from another storage medium (such as an SD card), or from a communication network (not shown). When the altimeter setting management system 101 is powered up, the processor 201 is capable of reading the abovementioned instructions from the RAM 202 and of executing them. When they are read (from the RAM 202 or a storage medium) and executed by the processor 201, these instructions (which form a computer program) cause the processor 201 to execute the behaviours, steps and algorithms described here.

All or some of the behaviours, steps and algorithms described here may thus be implemented in software form by executing a set of instructions using a programmable machine, such as a DSP (digital signal processor) or a microcontroller, or be implemented in hardware form by a machine or a dedicated component (chip) or a dedicated set of components (chipset), such as an FPGA (field-programmable gate array) or ASIC (application-specific integrated circuit). Generally, the altimeter setting management system 101 comprises electronic circuitry designed and configured to implement the behaviours, steps and algorithms described here.

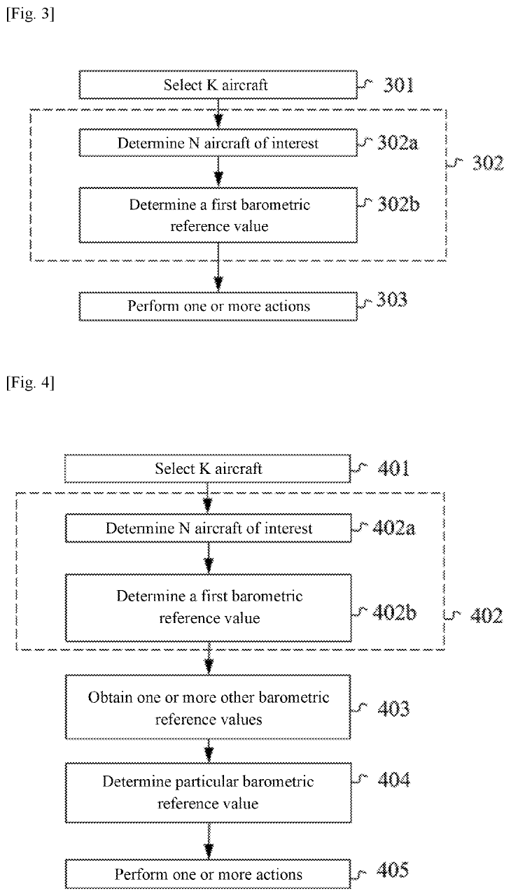

FIG. 3 schematically illustrates an algorithm for managing the setting of a barometric altimeter, executed by the altimeter setting management system 101 of FIG. 1, in a first embodiment.

In a step 301, the system 101 selects, as a function of one or more selection criteria (belonging to a group of criteria; see the explanations below), a set comprising K aircraft distinct from the aircraft 100, called “aircraft of interest” in the remainder of the description, with K≥2. Each aircraft of interest comprises a barometric altimeter that has been set beforehand with a barometric reference value specific to this aircraft of interest. For example, the crew of each aircraft of interest has been in voice contact with an ATC and has entered a barometric reference value received from ATC.

The selection criteria are chosen for example so that the selection of the K aircraft of interest takes into account the following situations (constraints):
on the ground, the time at which the barometric reference is entered by the crew depends on the standard operating procedure and may vary considerably depending on the operator's procedures and/or ATC practices (this time may be before pushback, during taxiing, before alignment with the runway);
after landing, on the ground during taxiing, the barometric reference value is no longer used, and there is therefore no guarantee that it remains unchanged by the crew or that it complies with the ATC authorization;
at take-off, the aircraft may be authorized to climb to cruising level; in this case, the barometric reference value may rapidly change from the value authorized for take-off (QNH) to the cruising value (STD);
during initial descent and approach, not all aircraft are expected to modify their barometric reference value at the same altitude. It may be expected that it will be modified only after having contacted the ATC responsible for the sector; and
during initial descent and approach, the ATC sector may be split into multiple control sub-sectors in the event of operation of two nearby airports with potentially different barometric references in each control sub-sector.

In one embodiment, multiple sub-groups (for example, three in the example described below) are distinguished within the group of criteria, and the K aircraft of interest are selected as a function of at least one combination of criteria comprising at least one selection criterion from each of the sub-groups. In other embodiments, the combination of criteria (or each combination if there are several thereof) comprises at least one criterion for only some of the sub-groups. In another embodiment, the group of criteria does not comprise sub-groups.

In one particular implementation, three sub-groups of criteria are distinguished, denoted A, B and C. The first sub-group A comprises the following criteria:
A1: to be an aircraft of interest, a candidate aircraft must be in flight;
A2: to be an aircraft of interest, a candidate aircraft must be on the ground, at a destination airport of the aircraft 100, and on a runway or at a distance from a runway less than a first predetermined distance threshold; and
A3: to be an aircraft of interest, a candidate aircraft must be on the ground and with a ground speed greater than a predetermined speed threshold.

The second sub-group B comprises the following criteria:
B1: to be an aircraft of interest, a candidate aircraft must be at a distance D1, from the destination airport of the aircraft 100, less than a second predetermined distance threshold;
B2: to be an aircraft of interest, a candidate aircraft must be at a distance D2, from a runway of the destination airport of the aircraft 100, less than a third predetermined distance threshold;
B3: to be an aircraft of interest, a candidate aircraft must belong to a set of M aircraft in flight closest to the destination airport of the aircraft 100, with 2≤M≤K; and
B4: to be an aircraft of interest, a candidate aircraft must be located in an ATC control sector around the destination airport of the aircraft 100.

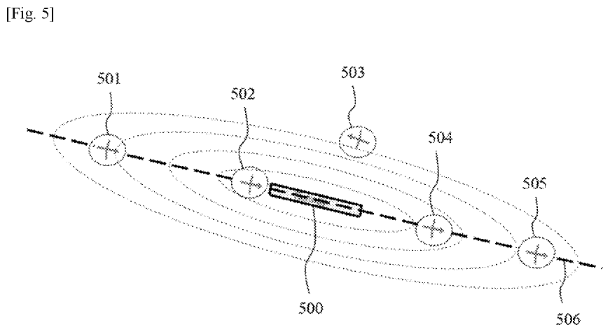

In one particular implementation, at least one of the distances D1 (of criterion B1) and D2(of criterion B2) is weighted as a function of a deviation between a position of the candidate aircraft and the centreline of a runway intended for the aircraft 100 at its destination airport. For example, the weighting consists in minimizing the distance D1 or D2 in proportion to this deviation. Thus, in this example, candidate aircraft aligned with the centreline of the abovementioned runway (the one intended for the aircraft 100) are given preference (smaller distance D1 or D2) over candidate aircraft that are far from this centreline. One example of this is illustrated in FIG. 5, in which the abovementioned runway is referenced 500 and the centreline thereof is referenced 506. The candidate aircraft referenced 501, 502, 504 and 505 are aligned with this centreline 506, this not being the case for the aircraft referenced 503. In this example, the candidate aircraft 501 will be able to be selected as an aircraft of interest, whereas the candidate aircraft 503, although it is closer to the runway 500, will not be selected.

The third sub-group C comprises the following criteria:
C1: to be an aircraft of interest, a candidate aircraft must be at a height, above the destination airport of the aircraft 100, less than a first predetermined height threshold;
C2: to be an aircraft of interest, a candidate aircraft must be at a height, above the destination airport of the aircraft 100, less than a second predetermined height threshold if the candidate aircraft is in the climbing phase and less than a third predetermined height threshold, different from the second height threshold, if the candidate aircraft is in the descent phase; and
C3: to be an aircraft of interest, a candidate aircraft must be at an altitude less than a current altitude of the aircraft 100, if the aircraft 100 is approaching its destination airport.

In one particular implementation, the first height threshold of criterion C1 depends on a transition altitude and/or a transition level (flight level) that are predefined for the destination airport of the aircraft 100.

First example: use a combination of criteria comprising at least one selection criterion from each of sub-groups A, B and C: take into account only aircraft in flight (criterion A1), at less than a determined distance from the destination airport of the aircraft 100 (for example 10 NM, with NM the unit of measurement “nautical mile”) (criterion B1) and below a given height above this airport (for example below 5000 ft, with ft the unit of measurement “foot”) (criterion C1).

Second example: use multiple combinations of criteria according to steps 1 to 6 described below.

Step 1: first, consider only aircraft in flight, aligned with the destination runway (that is to say with, for each candidate aircraft, a deviation E, between a position of the candidate aircraft and the centreline of the intended runway at the destination airport of the aircraft 100, less than a deviation threshold S), at less than 10 NM from this runway (distance threshold), and below 4000 ft (height threshold).

Step 2: if fewer than N+1 aircraft meet the conditions from step 1, additionally consider all runways parallel to the intended runway (and not just the intended runway), with, for the rest, conditions similar to those from step 1 (aircraft in flight, at less than 10 NM from the runway, and below 4000 ft), otherwise proceed to step 6.

Step 3: if fewer than N+1 aircraft meet the conditions from step 2, additionally consider aircraft on the ground and near runways (that is to say at the destination airport of the aircraft 100, and on a runway or at a distance from a runway less than a first distance threshold), otherwise proceed to step 6.

Step 4: if fewer than N+1 aircraft meet the conditions from step 3, additionally consider all aircraft in the control sector of the destination airport of the aircraft 100, and below a predetermined transition altitude (altitude threshold), otherwise proceed to step 6.

Step 5: if fewer than N+1 aircraft meet the conditions from step 4, declare that there are not enough aircraft to determine an error-free barometric reference, otherwise proceed to step 6.

Step 6: if at least N aircraft (among the at least N+1 aircraft meeting the conditions from step 2, 3, 4 or 5) share one and the same barometric reference value (that is to say have consistent values), then this value, which is probably relevant and error-free, is adopted as the determined first barometric reference value at the end of step 302 of FIG. 3 (see below).

The solution proposed in this second example makes it possible to take into account only a limited number of aircraft while at the same time ensuring that a sufficient number of aircraft are used, thereby making it possible to maximize the chances of obtaining a precise and error-free first barometric reference value, while at the same time taking into account the diversity of operational procedures and having the ability to adapt to various ATC environments. Thus, at a very busy destination airport, only aircraft in flight and close to take-off or landing will be selected whereas, in a less dense area, all aircraft in the sector will be taken into account, including those on the ground.

In a step 302, the system 101 determines a first barometric reference value specific to the aircraft 100 (sometimes simply called “first value” in the remainder of the description), as a function of the K barometric reference values specific to the K aircraft of interest selected in step 301.

In one particular implementation, step 302 itself comprises sub-steps 302a and 302b. In sub-step 302a, the system 101 determines, among the K aircraft of interest, at least N aircraft of interest sharing one and the same particular barometric reference value, with 2≤N≤K. In sub-step 302b, the system 101 adopts, for the first barometric reference value, the particular barometric reference value shared by the at least N aircraft of interest.

The use of N aircraft of interest sharing one and the same value, along with the use of specific logic, makes it possible to avoid unwarranted alerts if one of the aircraft of interest has had its barometric altimeter set with an incorrect barometric reference value. Indeed, it may reasonably be assumed that the probability of the crew of an aircraft of interest making an error (with regard to the barometric reference value) is relatively low (typically less than 10⁻³/FH). Therefore, if at least N aircraft of interest share one and the same barometric reference value, the probability of this value being incorrect becomes even lower (N=3 leads to a probability of less than 3×10⁻⁹/FH, with an assumed probability of error of 10⁻³/FH per crew).

In a step 303, the system 101 performs at least one of the actions described below.

Action 1: triggering an alert if a deviation between the first barometric reference value and a barometric reference value entered by a crew on board the aircraft 100 is greater than a predetermined threshold. With the proposed solution, an alert is therefore triggered only if the barometric reference value entered by the crew is incorrect, since the proposed solution guarantees a very low probability of error with regard to the first barometric reference value determined in step 302b.

Action 2: suggesting to the crew on board the aircraft 100 to use the first barometric reference value (which, as already mentioned above, has a very low probability of error) to set the barometric altimeter present in the aircraft 100.

Action 3: supplying the first reference value to an automatic barometric altimeter setting device for setting the barometric altimeter present in the aircraft 100. This facilitates the work of the crew while at the same time guaranteeing a very low probability of error.

FIG. 4 schematically illustrates an algorithm for managing the setting of a barometric altimeter, executed by the altimeter setting management system 101 of FIG. 1, in a second embodiment.

Steps 401 and 402 (comprising 402a and 402b) are identical to steps 301 and 302 (comprising 302a and 302b) of FIG. 3.

Step 402 is followed by a step 403 in which the system 101 obtains at least one other barometric reference value specific to the aircraft 100. Each other barometric reference value is supplied by a distinct source and is independent of the first barometric reference value determined in step 402 (that is to say not determined as a function of the K barometric reference values specific to the K aircraft of interest).

In one embodiment, steps 401 and 402, the performance of which makes it possible to determine the first barometric reference value, are called “source I”, and the following four sources, which make it possible to supply four barometric reference values, are called “source II” to “source IV”:
source II supplies a barometric reference value entered by the crew on board the aircraft 100, during a cruise phase of the aircraft 100 before starting a descent;
source III supplies a barometric reference value received via a “digital ATIS” service broadcast by the destination airport of the aircraft 100;
source IV supplies a barometric reference value resulting from application of a voice recognition technique to a voice authorization transmitted by an air traffic control (ATC) service for the destination airport of the aircraft 100; and
source V supplies an estimate of a barometric reference value based on measurements supplied by sensors on board the aircraft 100, location information supplied by a satellite positioning system (GPS) and known altitude information concerning the destination airport of the aircraft 100.

In a step 404, the system 101 determines, within a set of values comprising the first barometric reference value and the one or more other values obtained in step 403, a particular barometric reference value having a number of occurrences greater than or equal to X, with X≥2. The probability of error with regard to the determined barometric reference value is thus further reduced.

In one embodiment of step 404, within the set of values, the occurrence of a barometric reference value supplied by a given source is weighted by a coefficient dependent on a priority level associated with this given source. In this embodiment, the number of occurrences of the particular barometric reference value takes into account the weighting of each occurrence.

In a step 405, the system 101 performs at least one of the following actions:
action 1′: triggering an alert if a deviation between the particular barometric reference value and a barometric reference value entered by the crew on board the aircraft 100 is greater than a predetermined threshold;
action 2′: suggesting to the crew on board the aircraft 100 to use the particular barometric reference value to set the barometric altimeter present in the aircraft 100; and
action 3′: supplying the particular barometric reference value to an automatic barometric altimeter setting device for setting the barometric altimeter present in the aircraft 100.

In other words, in step 405, and by comparison with step 303 of FIG. 3, the particular barometric reference value (determined in step 404) is used instead of the first barometric reference value if the particular value is different from the first value.

In one embodiment of step 405, the choice of the one or more actions performed depends on the number of occurrences (determined in step 404) of the particular barometric reference value.

For example, the choice of the one or more actions performed depends on a score associated with the particular barometric reference value and depends on the number of occurrences of this particular barometric reference value.

In one particular implementation, in which the first barometric reference value is supplied by abovementioned source I (that is to say by performing steps 401 and 402) and in which the other barometric reference values are supplied by abovementioned sources II to V, the score is calculated as follows:
step 1′: when all of the exact values (supplied by sources I, II, III and IV) are available, ensure that at least three of them are identical (consistent) to declare that the particular barometric reference value is available with a score of 4, otherwise proceed to step 2′;
step 2′: ensure that at least two of the values supplied by sources II, IV and V are identical (consistent) and within a predetermined range around the value estimated by source V to declare that the particular barometric reference value is available with a score of 3, otherwise proceed to step 3′;
step 3′: if only one of the values supplied by sources I, III and IV is available and consistent with the value estimated by source V, then declare that the particular barometric reference value is available with a score of 2, otherwise proceed to step 4′;
step 4′: if only the value estimated by source V is available, then declare that the particular barometric reference value is available with a score of 1, otherwise proceed to step 5′; and
step 5′: declare that no particular barometric reference value is available.

In addition, in the abovementioned particular implementation, the choice of the one or more actions performed depending on the score may be summarized as follows:
if the score is greater than or equal to 2, abovementioned action 1′ is performed (triggering an alert if the deviation between the particular barometric reference value and the barometric reference value entered by the crew is greater than a predetermined threshold);
if the score is greater than or equal to 3, abovementioned action 2′ is performed (suggesting to the crew to use the particular barometric reference value); and
if the score is equal to 4, abovementioned action 3′ is performed (supplying the particular barometric reference value to an automatic barometric altimeter setting device).

1. A method for managing the setting of a barometric altimeter present in a given aircraft, the method being implemented by a setting management system comprising electronic circuitry, the method comprising:
selecting a set comprising K aircraft of interest, distinct from the given aircraft, with ≥2, as a function of at least one selection criterion, each of the aircraft of interest comprising a barometric altimeter set with a barometric reference value specific to said aircraft of interest;
determining a first barometric reference value specific to the given aircraft, as a function of the K barometric reference values specific to the K aircraft of interest;
performing at least one action belonging to a group comprising:
triggering an alert if a deviation between the first barometric reference value and a barometric reference value entered by a crew on board the given aircraft is greater than a predetermined threshold;
suggesting to the crew on board the given aircraft to use the first barometric reference value to set the barometric altimeter present in the given aircraft; and
supplying the first reference value to an automatic barometric altimeter setting device for setting the barometric altimeter present in the given aircraft; and
obtaining at least one other barometric reference value specific to the given aircraft, each other barometric reference value being supplied by a distinct source and not being determined as a function of the K barometric reference values specific to the K aircraft of interest; and
determining, within a set of values comprising the first barometric reference value and said at least one other barometric reference value, a particular barometric reference value having a number of occurrences greater than or equal to a predetermined value greater than or equal to two;
wherein, when said at least one action is performed, the particular barometric reference value is used instead of the first barometric reference value if the particular barometric reference value is different from the first barometric reference value.

2. The method according to claim 1, wherein determining the first barometric reference value comprises:
determining, among the K aircraft of interest, at least N aircraft of interest sharing one and the same particular barometric reference value, with 2≤N≤K; and
adopting, for the first barometric reference value, the particular barometric reference value shared by the at least N aircraft of interest.

3. The method according to claim 1, wherein said at least one selection criterion belongs to a group comprising:
a first sub-group comprising:
to be an aircraft of interest, a candidate aircraft must be in flight;
to be an aircraft of interest, a candidate aircraft must be on the ground, at a destination airport of the given aircraft, and on a runway or at a distance from a runway less than a first predetermined distance threshold;
to be an aircraft of interest, a candidate aircraft must be on the ground and with a ground speed greater than a predetermined speed threshold;
a second sub-group comprising:
to be an aircraft of interest, a candidate aircraft must be at a distance, from the destination airport of the given aircraft, less than a second predetermined distance threshold;
to be an aircraft of interest, a candidate aircraft must be at a distance, from a runway of the destination airport of the given aircraft, less than a third predetermined distance threshold;
to be an aircraft of interest, a candidate aircraft must belong to a set of M aircraft in flight closest to the destination airport of the given aircraft, with 2≤M≤K; and
to be an aircraft of interest, a candidate aircraft must be located in an ATC control sector around the destination airport of the given aircraft;
a third sub-group comprising:
to be an aircraft of interest, a candidate aircraft must be at a height, above
the destination airport of the given aircraft, less than a first predetermined height threshold;
to be an aircraft of interest, a candidate aircraft must be at a height, above the destination airport of the given aircraft, less than a second predetermined height threshold if the candidate aircraft is in the climbing phase and less than a third predetermined height threshold, different from the second height threshold, if the candidate aircraft is in the descent phase; and
to be an aircraft of interest, a candidate aircraft must be at an altitude less than a current altitude of the given aircraft, if the given aircraft is approaching the destination airport of the given aircraft.

4. The method according to claim 3, wherein the set of K aircraft of interest is selected as a function of at least one combination of criteria comprising at least one selection criterion from the first sub-group, at least one selection criterion from the second sub-group and at least one selection criterion from the third sub-group.

5. The method according to claim 3, wherein at least one distance, among the distance from the destination airport and the distance from a runway of the destination airport, is weighted as a function of a deviation between a position of the candidate aircraft and the centreline of a runway intended for the given aircraft at the destination airport.

6. The method according to claim 3, wherein the first predetermined height threshold depends on at least one item of information among a transition altitude and a transition level that are predefined for the destination airport of the given aircraft.

7. The method according to claim 1, wherein, within the set of values, the occurrence of a barometric reference value supplied by a given source is weighted by a coefficient dependent on a priority level associated with said given source, and wherein the number of occurrences of the particular barometric reference value takes into account the weighting of each occurrence.

8. The method according to claim 1, wherein a choice of the one or more actions performed depends on the number of occurrences of the particular barometric reference value.

9. The method according to claim 1, wherein said at least one other barometric reference value is supplied by a source belonging to a group comprising:
a first source supplying a barometric reference value entered by the crew on board the given aircraft, during a cruise phase of the given aircraft before starting a descent;
a second source supplying a barometric reference value received via a “digital ATIS” service broadcast by the destination airport of the given aircraft;
a third source supplying a barometric reference value resulting from application of a voice recognition technique to a voice authorization transmitted by an air traffic control (ATC) service for the destination airport of the given aircraft; and
a fourth source supplying an estimate of a barometric reference value based on measurements supplied by sensors on board the given aircraft, location information supplied by a satellite positioning system (GPS) and known altitude information concerning the destination airport of the given aircraft.

10. (canceled)

11. A non-transitory storage medium storing a computer program comprising instructions that cause a processor to perform the method according to claim when said instructions are read from the storage medium and executed by the processor.

12. A system for managing the setting of a barometric altimeter present in a given aircraft, comprising electronic circuitry configured to implement the following:
selecting a set comprising K aircraft of interest, distinct from the given aircraft, with K≥2, as a function of at least one selection criterion, each of the aircraft of interest comprising a barometric altimeter set with a barometric reference value specific to said aircraft of interest;
determining a first barometric reference value specific to the given aircraft, as a function of the K barometric reference values specific to the K aircraft of interest;
performing at least one action belonging to a group comprising:
triggering an alert if a deviation between the first barometric reference value and a barometric reference value entered by a crew on board the given aircraft is greater than a predetermined threshold;
suggesting to the crew on board the given aircraft to use the first barometric reference value to set the barometric altimeter present in the given aircraft; and
supplying the first reference value to an automatic barometric altimeter setting device for setting the barometric altimeter present in the given aircraft; and
obtain at least one other barometric reference value specific to the given aircraft, each other barometric reference value being supplied by a distinct source and not being determined as a function of the K barometric reference values specific to the K aircraft of interest,
determine, within a set of values comprising the first barometric reference value and said at least one other barometric reference value, a particular barometric reference value having a number of occurrences greater than or equal to a predetermined value greater than or equal to two,
wherein, when said at least one action is performed, use the particular barometric reference value instead of the first barometric reference value if the particular barometric reference value is different from the first barometric reference value.

13. An aircraft comprising the system according to claim 12.
